(19) United States
(12) Patent Application Publication
(10) Pub. No.: US 2016/0032636 A1
(43) Pub. Date: Feb. 4, 2016

(54) AMERICAN DAMPER CONCEALED HINGE

(71) Applicant: Zhongshan Sheng Tai Metal Products Co., Ltd., Zhongshan (CN)

(72) Inventor: Guiyang Dai, Zhongshan (CN)

(21) Appl. No.: 14/554,729

(22) Filed: Nov. 26, 2014

(30) Foreign Application Priority Data
Jul. 29, 2014 (CN) 201410368063.2

(51) Int. Cl. E05F 5/00; E05D 11/08; E05D 3/02

(52) U.S. Cl. CPC E05F 5/006; E05D 3/02; E05D 11/082

(57) ABSTRACT

An American damper concealed hinge comprises a first base, a second base, a hinging rotation arm, one end of the hinging rotation arm being hinged to the first base, the other end of the hinging rotation arm being hinged to the second base, the first base being provided with a cavity; wherein the cavity is internally provided with a damper device that is drivable by the hinging rotation arm, left and right sides of the damper device being respectively provided with a first baffle and a second baffle, a first torsion spring being disposed between the first baffle and a left side wall of the first base, a second torsion spring being disposed between the second baffle and a right side wall of the first base, a first extending leg of the first torsion spring and a first extending leg of the second torsion spring being respectively pressed onto the hinging rotation arm, and a second extending leg of the first torsion spring and a second extending leg of the second torsion spring being respectively pressed onto the first base.

### CROSS-REFERENCE TO RELATED APPLICATIONS

The present application claims priority from Chinese Patent Application No. 201410368063.2 filed Jul. 29, 2014, the disclosure of which is hereby incorporated herein by reference.

### FIELD OF THE INVENTION

The present invention relates to the field of hinges, and in particular, relates to an American damper concealed hinge capable of implementing three-dimensional six-way adjustment.

### BACKGROUND OF THE INVENTION

At present, there are various types of damper hinges available for use in doors of furniture. The structures and working principles thereof vary. Traditional concealed hinges only achieve two-dimensional adjustment of the door, failing to accommodate the need of three-dimensional adjustment for high-end furniture doors. To solve this problem, concealed hinges for use in furniture doors have been designed in the industry. For example, the Chinese Patent Application No. 200420095620.X has disclosed a concealed hinge for use in furniture doors that is capable of achieving three-dimensional adjustment. However, there is still a great margin for improvement of the reliability. Due to resilience of the spring, during closing of the door, the door may be subjected to collision with the door frame, and thus great sounds may be generated, which may even damage or break articles that are fragile or improperly placed in the cabinets. In view of the above, a hinge having a buffering function has been invented. However, a conventional buffering-capable hinge is generally complicated in terms of structure, and the manufacture cost thereof is high. Moreover, in case of failure, the hinge is inconvenient to repair. Therefore, some improvements are desired for the conventional hinge.

### BRIEF SUMMARY OF THE INVENTION

An objective of the present invention is to overcome at least one defect in the prior art, and to provide an American damper concealed hinge having a simple structure and a buffering function.

To achieve the above objective, the present invention employs the following technical solution: an American damper concealed hinge, comprising a first base, a second base, a hinging rotation arm, one end of the hinging rotation arm being hinged to the first base, the other end of the hinging rotation arm being connected to the second base, the first base being provided with a cavity; wherein the cavity is internally provided with a damper device that is drivable by the hinging rotation arm, left and right sides of the damper device being respectively provided with a first baffle and a second baffle, a first torsion spring being disposed between the first baffle and a left side wall of the first base, a second torsion spring being disposed between the second baffle and a right side wall of the first base, a first extending leg of the first torsion spring and a first extending leg of the second torsion spring being respectively pressed onto the hinging rotation arm, and a second extending leg of the first torsion spring and a second extending leg of the second torsion spring being respectively pressed onto the first base.

In the above technical solution, since a damper device is installed on the first base, when the door is being closed, the hinging rotation arm approaches the first base under action of a closing force of the first and second torsion springs. When the hinging rotation arm reaches a predetermined angle during approaching the first base, the hinging rotation arm starts driving the damper device such that the hinging rotation arm is retarded in approaching the first base until the door is completely closed, thereby achieving the buffering effect and preventing severe collision between the door and the door frame.

For ease of installation of the torsion spring, a first support shaft is disposed between the first baffle and the left side wall of the first base, the first torsion spring being sleeved onto the first support shaft; and a second support shaft is disposed between the second baffle and the right side wall of the first base, the second torsion spring being sleeved onto the second support shaft.

Further, the second extending leg of the first torsion spring and the second extending leg of the second torsion spring are pressed onto a bottom of the cavity of the first base.

Further, a tail end of the second extending leg of the first torsion spring is connected to a tail end of the second extending leg of the second torsion spring. In this technical solution, the first torsion spring and the second torsion spring may be an integral body.

A driving face of the hinging rotation arm is disposed on one side of the hinging rotation arm corresponding to the damper device, and the damper device comprises a cylinder, a piston rod, a piston, and a spring, the cylinder being disposed between the first baffle and the second baffle and being movable between the first baffle and the second baffle, the piston being disposed in a hollow lumen of the cylinder, one end of the piston rod being connected to the piston, the other end of the piston rod being disposed in an exterior of the cylinder, one end of the spring being in contact with the piston, the other end of the spring being in contact with an inner wall of the cylinder, the piston rod being disposed on one end in the exterior of the cylinder and in contact with the first base, and the driving face of the hinging rotation arm being contactable with the cylinder and capable of pushing the cylinder. In this technical solution, a compression spring is employed for buffering in door closing, such that the structure is simplified. In this way, the manufacture cost is reduced, and the driving face of the hinging rotation arm pushes the cylinder to implement the buffering.

For prevention of the damper device from detaching from the cavity of the first base, a damper seat is disposed over the damper device, a first securing plate and a second securing plate being disposed on a lower side of the damper seat, the first securing plate being connected to the first support shaft, and the second securing plate being connected to the second support shaft.

For two-dimensional multi-way adjustment of the door, the second base comprises a bottom plate and a top plate, the top plate being disposed over the bottom plate and being movably connected to the bottom plate, and the top plate being connected to the hinging rotation arm. In practical use, the position of the door may be adjusted by adjusting the position of the top plate with respect to the bottom plate. It is unnecessary to adjust the door by releasing the screws securing the hinge to the door or the door frame.

For two-dimensional multi-way adjustment of the door, an intermediate plate is disposed between the bottom plate and the top plate, the intermediate plate being movably connected to the bottom plate via a first off-center adjusting rivet, and the top plate being movably connected to the intermediate plate via a second off-center adjusting rivet.

Further, for forward or backward adjustment of the door, the hinging rotation arm is movably connected to the top plate via a third off-center adjusting rivet.

According to the present invention, since baffles are respectively disposed on left and right sides of a cylinder of the damper device, for limiting the left and right sides of the cylinder and ensuring stable reciprocal sliding of the cylinder, with no need of limiting the left and right sides of the cylinder by stamping the cavity of the first base into a flat shape, such that the shape of the first base is simplified. In addition, a support shaft is disposed between the baffle and an inner wall of the cavity of the first base, for installing the torsion spring, thereby facilitating installation of the torsion spring. During closing the door, the first and second torsion springs provide a closing force, and when the door rotates to a predetermined angle, the driving face of the hinging rotation arm pushes the cylinder of the damper device to move forward. Spring action of the damper device retards the movement of the cylinder with respect to the piston rod, thereby achieving slow closing of the door, preventing great sounds caused by collision of the door with the door frame during closing the door with an over-great force, and meanwhile protecting the hinge and the door from being damaged. In addition, three-dimensional six-way movement of the door with respect to the door frame may be achieved by respectively adjusting the first, second, and third off-center adjusting rivets, with no need of releasing the screws securing hinge to the door or the door frame. The solution is convenient and stable and reliable.

### BRIEF DESCRIPTION OF DRAWINGS

FIG. 1 is a schematic view of an axial side of an American damper concealed hinge according to the present invention;

FIG. 2 is a schematic exploded view of the American damper concealed hinge according to the present invention;

FIG. 3 is a schematic view of an open state of the American damper concealed hinge when the door is opened according to the present invention;

FIG. 4 is a schematic view of a closed state of the American damper concealed hinge when the door is closed according to the present invention;

FIG. 5 is a schematic view of start-buffering of the American damper concealed hinge according to the present invention;

FIG. 6 is a schematic exploded view of a damper seat, a damper device, and a first base according to the present invention;

FIG. 7 is a schematic structural view of the American damper concealed hinge (with the damper seat detached) according to the present invention; and

FIG. 8 is a schematic structural view of the damper device according to the present invention.

### DETAILED DESCRIPTION

The present invention is further described with reference to specific embodiments. The drawings are schematic views for illustration purpose only, but shall not be construed as limitations to the present invention. For better illustration of the following embodiments, some parts or components would be omitted, scaled up or scaled down in the drawings, which are not indicative of the practical sizes. For a person skilled in the art, it shall be understandable that some commonly known structures and description thereof are omitted for brevity.

### Embodiment 1

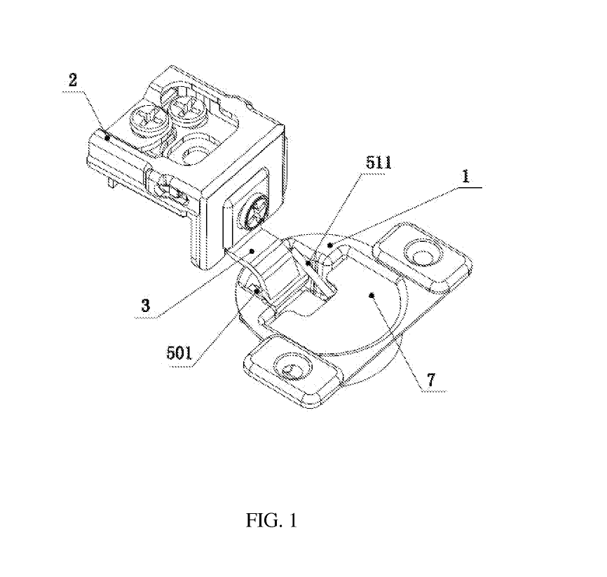

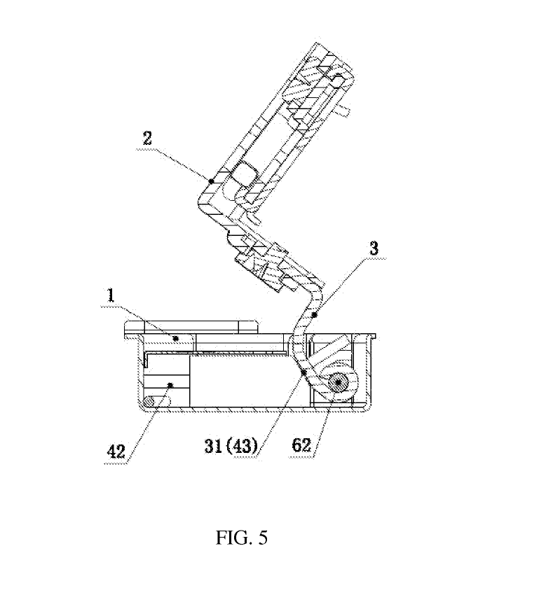

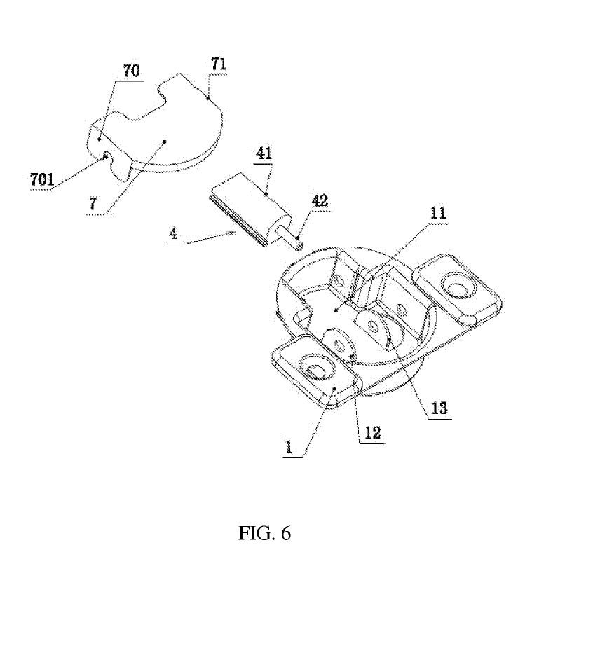

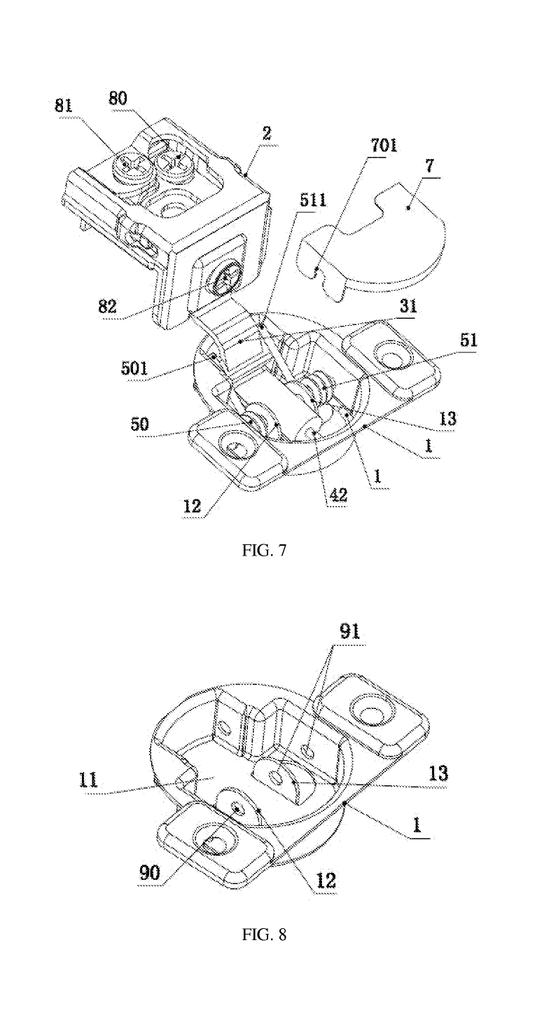

FIG. 1 to FIG. 8 illustrates the structure of an American damper concealed hinge according to this embodiment. The American damper concealed hinge comprises: a first base 1, a second base 2, a hinging rotation arm 3, a damper device 4, a first torsion spring 50, and a second torsion spring 51. One end of the hinging rotation arm 3 is hinged to the first base 1 via a hinge shaft 62, and the other end of the hinging rotation arm 3 is connected to the second base 2. The first base 1 is provided with a cavity 11. The damper device 4 is disposed within the cavity 11 of the first base 1, and comprises a cylinder 41, a piston rod 42, a piston, and a spring. The piston is disposed in a hollow lumen of the cylinder 41. One end of the piston rod 42 is connected to the piston, and the other end of the piston rod 42 is disposed in an exterior of the cylinder 41. One end of the spring is in contact with the piston, and the other end of the spring is in contact with an inner wall of the cylinder 41. The piston rod 42 is disposed at one end in the exterior of the cylinder 51 and in contact with an inner wall of the first base 1. A first baffle 12 and a second baffle 13 are respectively disposed at a bottom portion of the cavity 11 of the first base 1 corresponding to left and right sides of the cylinder 41. The cylinder 41 is disposed between the first baffle 12 and the second baffle 13, and is forward or backward movable between the first baffle 12 and the second baffle 13. When the door is closed to a specific angle, the hinging rotation arm 3 is in contact with a tail portion of the cylinder 41 and pushes the cylinder 41 forward, thereby implementing buffering of door closing. The first baffle 12 and a left side wall of the first base 1 are each provided with a shaft hole 90. A first support shaft 60 is disposed between the first baffle 12 and the left side wall of the first base 1. The two ends of the first support shaft 60 are respectively secured to the shaft holes 90 of the first baffle 12 and the left side wall of the first base 1. The second baffle 13 and a right side wall of the first base 1 are each provided with a shaft hole 91. A second support shaft 61 is disposed between the second baffle 13 and the right side wall of the first base 1. The two ends of the second support shaft 61 are respectively secured to the shaft holes 91 of the second baffle 13 and the right side wall of the first base 1. The first torsion spring 50 is sleeved onto the first support shaft 60, and is disposed between the first baffle 12 and the left side wall of the first base 1. The second torsion spring 51 is sleeved onto the second support shaft 61, and is disposed between the second baffle 13 and the right side wall of the first base 1.

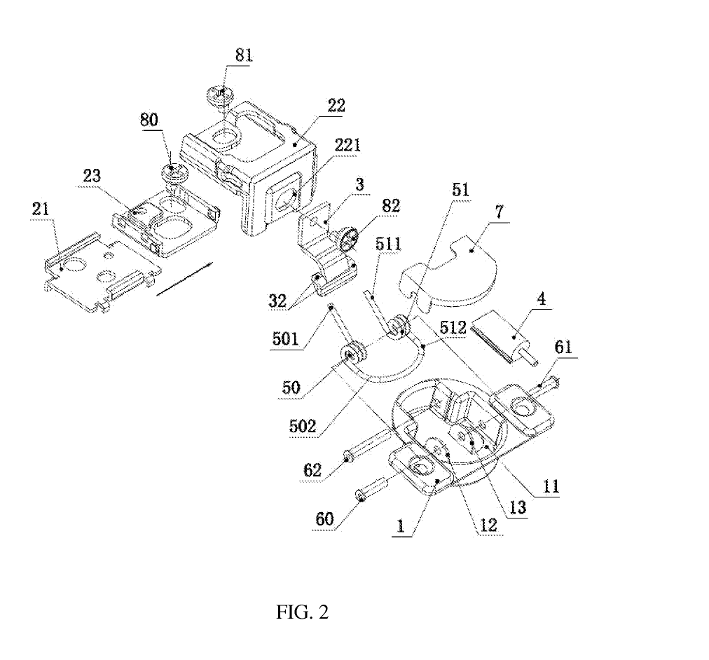

A bearing portion 32 is disposed on each of the left and right sides of the hinging rotation arm 3 close to the hinge end of the first base 1. A first extending leg 501 of the first torsion spring 50 and a first extending leg 511 of the second torsion spring 51 are respectively pressed on the bearing portions 32 on the left and right sides of the hinging rotation arm 3. A second extending leg 502 of the first torsion spring 50 and the second extending leg 512 of the second torsion spring 51 are respectively pressed on a bottom portion of the cavity 11 of the first base 1. Preferably, a tail end of the second extending leg 502 of the first torsion spring 50 is connected to a tail end of the second extending leg 512 of the second torsion spring 51. To be specific, the first torsion spring 50 and the second torsion spring 51 are defined into an integral structure, as illustrated in FIG. 2.

A driving face 31 of the hinging rotation arm 3 is disposed on one side of the hinging rotation arm 3 corresponding to the damper device 4. The driving face 31 of the hinging rotation arm 3 is in contact with a tail portion of the cylinder to push the cylinder 41 forward. In this embodiment, an inclined face 43 is disposed at an upper end of the tail portion of the cylinder 41. The driving face 31 of the hinging rotation arm 3 is in contact with the inclined face 43 at the upper end of the tail portion of the cylinder 41 to push the cylinder 41. For prevention of the damper device 4 from detaching from the cavity of 11 of the first base 1, a damper seat 7 is disposed over the damper device 4. A first securing plate 70 and a second securing plate 71 are disposed on lower left and right sides of the damper seat 7. A lower end of the first securing plate 70 and a lower end of the second securing plate 71 are each provided with a connection hole 701. The first support shaft 60 penetrates through the connection hole 701 at the lower end of the first securing plate 70. The second support shaft 61 penetrates through the connection hole 701 at the lower end of the second securing plate 71. In this way, the damper seat 7 is securely installed.

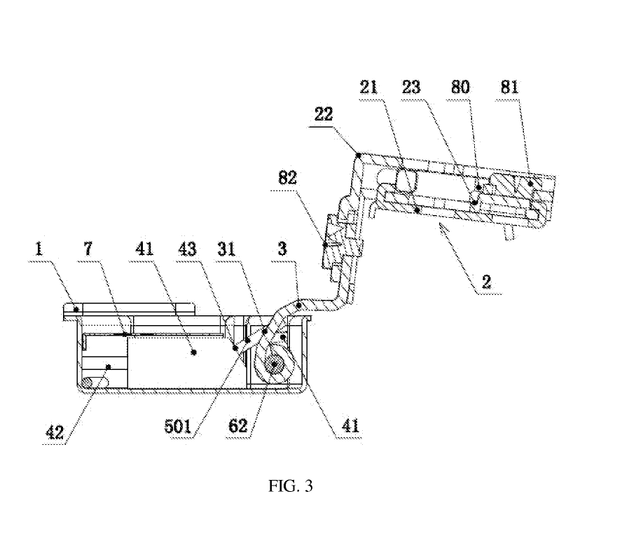

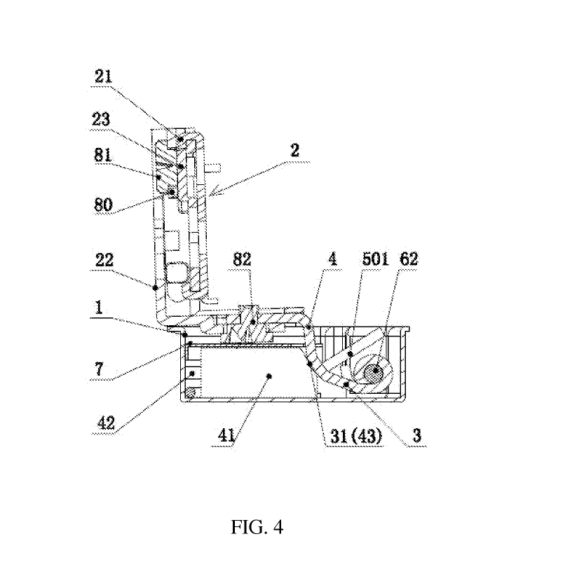

In practical use of the hinge according to this embodiment, the first base 1 is secured on the door, and the second base 2 is secured to the door frame. FIG. 3 illustrates an open state when the door is opened, and FIG. 4 illustrates a closed state when the door is closed. When the door is being closed under driving of an externally applied force, the door drives the first base 1 to rotate clockwise. During the rotation, under action of the first torsion spring 50 and the second torsion spring 51, the closing force between the hinging rotation arm 3 and the first base 1 is gradually increased. When the first base 1 clockwise rotates to a specific angle, the closing force between the hinging rotation arm 3 and the first base 1 causes the door to close with no need of an externally applied force. With the door continuously rotating along a closing direction, the closing force is gradually increased. When the door is closed to a specific angle, the driving face 31 of the hinging rotation arm 3 is in contact with the inclined face 43 at the upper end of the tail portion of the cylinder 41, and the piston rod 42 compresses the spring via the piston to cause the spring to inwardly slowly moved (that is, the cylinder slides forward). In this case, the door is being closed slowly until reaching the closed state as illustrated in FIG. 4, i.e., the door is completely closed.

When an external force is applied to open the door, the door drives the first base 1 to counterclockwise rotate. During the rotation, under action of the first torsion spring 50 and the second torsion spring 51, the closing force between the hinging rotation arm 3 and the first base 1 is gradually decreased, and meanwhile the driving face 31 of the hinging rotation arm 3 moves far away from the inclined face 43 of the cylinder 41. In this way, the piston drives the piston rod 42 to automatically reset under action of the spring (that is, the cylinder 41 slides backward). When the first base 1 counterclockwise rotates to a specific angle, the closing force between the hinging rotation arm 3 and the first base 1 is such decreased that the door would not be automatically closed until reaching the open state as illustrated in FIG. 3, i.e., the door is completely opened.

### Embodiment 2

The structure in this embodiment is similar to that in Embodiment 1, as illustrated in FIG. 1 to FIG. 4. The difference lies in that: The second base 2 comprises a bottom plate 21, an intermediate plate 23, and a top plate 22. The intermediate plate 23 is disposed between the bottom plate 21 and the top plate 22, and is movably connected to the bottom plate 21 via a first off-center adjusting rivet 80. By rotating the first off-center adjusting rivet 80, the intermediate plate 23 moves left or right with respect to the bottom plate 21, such that the door is adjusted to move left or right with respect to the door frame. The top plate 22 is movably connected to the intermediate plate 23 via a second off-center adjusting rivet 81. By rotating the second off-center adjusting rivet 81, the top plate 22 moves up or down with respect to the intermediate plate 23, such that the door is adjusted to move up or down with respect to the door frame. A groove 221 is provided on a back face of the top plate 22 corresponding to one side of the first base 1. A connection end of the hinging rotation arm 3 and the second base 2 is disposed within the groove 221, and is connected to a bottom portion of the groove 221 of the top plate 22 via a third off-center adjusting rivet 82. By rotating the third off-center adjusting rivet 82, the hinging rotation arm 3 and the first base 1 move forward or backward with respect to the door frame, such that the door is adjusted to move forward or backward with respect to the door frame.

In practical use of the hinge according to this embodiment, if the position of the door with respect to the door frame needs to be slightly adjusted for better cooperation of the door and the door frame, only by rotating the first, second, and third off-center adjusting rivets 80, 81, and 82, three-dimensional six-way movement, i.e., left and right, up and down, and forward and backward, of the door with respect to the door frame may be achieved, with no need of release the screws securing the hinge to the door or the door frame. The solution is convenient and stable and reliable.

In the above embodiment, identical or like reference numerals denote identical or similar parts or components; position relations illustrated in the drawings are merely for illustrative description, and shall not be understood as limitations to the present invention. Obviously, the above embodiment is merely an exemplary one for illustrating the present invention, but is not intended to limit the implementation of the present invention. Persons of ordinary skills in the art may derive other modifications and variations based on the above embodiment. All embodiments of the present invention are not exhaustively listed herein. Any modification, equivalent replacement, or improvement made without departing from the spirit and principle of the present invention should fall within the protection scope of the present invention.

1. An American damper concealed hinge, comprising a first base, a second base, a hinging rotation arm, one end of the hinging rotation arm being hinged to the first base, the other end of the hinging rotation arm being connected to the second base, the first base being provided with a cavity; wherein the cavity is internally provided with a damper device that is drivable by the hinging rotation arm, left and right sides of the damper device being respectively provided with a first baffle and a second baffle, a first torsion spring being disposed between the first baffle and a left side wall of the first base, a second torsion spring being disposed between the second baffle and a right side wall of the first base, a first extending leg of the first torsion spring and a first extending leg of the second torsion spring being respectively pressed onto the hinging rotation arm, and a second extending leg of the first torsion spring and a second extending leg of the second torsion spring being respectively pressed onto the first base.

2. The American damper concealed hinge according to claim 1, wherein: a first support shaft is disposed between the first baffle and the left side wall of the first base, the first torsion spring being sleeved onto the first support shaft; and a second support shaft is disposed between the second baffle and the right side wall of the first base, the second torsion spring being sleeved onto the second support shaft.

3. The American damper concealed hinge according to claim 2, wherein the second extending leg of the first torsion spring and the second extending leg of the second torsion spring are pressed onto a bottom of the cavity of the first base.

4. The American damper concealed hinge according to claim 3, wherein a tail end of the second extending leg of the first torsion spring is connected to a tail end of the second extending leg of the second torsion spring.

5. The American damper concealed hinge according to claim 1, wherein a driving face of the hinging rotation arm is disposed on one side of the hinging rotation arm corresponding to the damper device, and the damper device comprises a cylinder, a piston rod, a piston, and a spring, the cylinder being disposed between the first baffle and the second baffle and being movable between the first baffle and the second baffle, the piston being disposed in a hollow lumen of the cylinder, one end of the piston rod being connected to the piston, the other end of the piston rod being disposed in an exterior of the cylinder, one end of the spring being in contact with the piston, the other end of the spring being in contact with an inner wall of the cylinder, the piston rod being disposed on one end in the exterior of the cylinder and in contact with the first base, and the driving face of the hinging rotation arm being contactable with the cylinder and capable of pushing the cylinder.

6. The American damper concealed hinge according to claim 2, wherein a damper seat is disposed over the damper device, a first securing plate and a second securing plate being disposed on a lower side of the damper seat, the first securing plate being connected to the first support shaft, and the second securing plate being connected to the second support shaft.

7. The American damper concealed hinge according to claim 1, wherein the second base comprises a bottom plate and a top plate, the top plate being disposed over the bottom plate and being movably connected to the bottom plate, and the top plate being connected to the hinging rotation arm.

8. The American damper concealed hinge according to claim 7, wherein an intermediate plate is disposed between the bottom plate and the top plate, the intermediate plate being movably connected to the bottom plate via a first off-center adjusting rivet, and the top plate being movably connected to the intermediate plate via a second off-center adjusting rivet.

9. The American damper concealed hinge according to claim 8, wherein the hinging rotation arm is movably connected to the top plate via a third off-center adjusting rivet.
